(19) United States
(12) Patent Application Publication
(10) Pub. No.: US 2015/0094860 A1
(43) Pub. Date: Apr. 2, 2015

(54) USE OF A GEO-FENCING PERIMETER FOR ENERGY EFFICIENT BUILDING CONTROL

(71) Applicants: Shaun Finnerty, Chicago, IL (US); Michael Pawlowski, Barlett, IL (US)

(72) Inventors: Shaun Finnerty, Chicago, IL (US); Michael Pawlowski, Barlett, IL (US)

(73) Assignee: SIEMENS INDUSTRY, INC., Alpharetta, GA (US)

(21) Appl. No.: 14/153,015

(22) Filed: Jan. 11, 2014

Related U.S. Application Data
(63) Continuation-in-part of application No. 14/040,214, filed on Sep. 27, 2013.
(60) Provisional application No. 61/923,511, filed on Jan. 3, 2014.

(51) Int. Cl. G05B 15/02

(52) U.S. Cl. CPC G05B 15/02
USPC 700/275

(57) ABSTRACT

A method and system of associating the personal remote mobile communications devices of occupants with the room and spaces they occupy in a building or other facility and generating commands to a building automation system based on changes in the location of the mobile communications devices relative to the associated room or space.

### CROSS-REFERENCE TO RELATED APPLICATIONS

This application claims priority of U.S. Provisional Patent Application Ser. No. 61/923,511 filed Jan. 3, 2014, entitled “Use of a Geo-Fencing Perimeter for Energy Efficient Building Control,” which application is incorporated herein by this reference.

### FIELD OF THE INVENTION

This application relates generally to building automation systems, and more particularly, to use of a virtual perimeter defining a building space in building automation systems to promote energy saving behavior of the building's occupants.

### BACKGROUND

Building automation systems encompass a wide variety of systems that aid in the monitoring and control of various aspects of building operation. Building automation systems (which may also be referred to herein as “building control systems”) include security systems, fire safety systems, lighting systems, and heating, ventilation, and air conditioning (“HVAC”) systems. Lighting systems and HVAC systems are sometimes referred to as “environmental control systems” because these systems control the environmental conditions within the building. A single facility may include multiple building automation systems (e.g., a security system, a fire system and an environmental control system). Multiple building automation systems may be arranged separately from one another or as a single system with a plurality of subsystems that are controlled by a common control station or server. The common control station or server may be contained within the building or remotely from the building, depending upon the implementation.

The elements of a building automation system may be widely dispersed throughout a facility or campus. For example, an HVAC system includes temperature sensors and ventilation damper controls as well as other elements that are located in virtually every area of a facility or campus. Similarly, a security system may have intrusion detection, motion sensors and alarm actuators dispersed throughout an entire building or campus. Likewise, fire safety systems include smoke alarms and pull stations dispersed throughout the facility or campus. The different areas of a building automation system may have different environmental settings based upon the use and personal likes of the people who occupy these areas, such as offices and conference rooms.

Building automation systems typically have one or more centralized control stations in which data from the system may be monitored, and in which various aspects of system operation may be controlled and/or monitored. The control station typically includes a computer or server having processing equipment, data storage equipment, and a user interface. To allow for monitoring and control of the dispersed control system elements, building automation systems often employ multi-level communication networks to communicate operational and/or alarm information between operating elements, such as sensors and actuators, and the centralized control station.

One example of a building automation system control station is the Apogee® Insight® Workstation, available from Siemens Industry, Inc., Building Technologies Division, of Buffalo Grove, Ill. (“Siemens”), which may be used with the Apogee® building automation system, also available from Siemens. In this system, several control stations connected via an Ethernet or another type of network may be distributed throughout one or more building locations, each having the ability to monitor and control system operation.

The typical building automation system (including those utilizing the Apogee® Insight® Workstation) has a plurality of field panels that are in communication with the central control station. While the central control station is generally used to make modifications and/or changes to one or more of the various components of the building automation system, a field panel may also be operative to allow certain modifications and/or changes to one or more parameters of the system. This typically includes changes to parameters such as temperature and lighting, and/or similar parameters.

The central control station and field panels are in communication with various field devices, otherwise known as “points.” Field devices are typically in communication with field panels of building automation systems and are operative to measure, monitor, and/or control various building automation system parameters. Example field devices include lights, thermostats, damper actuators, alarms, HVAC devices, sprinkler systems, speakers, door locks, and numerous other field devices as will be recognized by those of skill in the art. These field devices receive control signals from the central control station and/or field panels. Accordingly, building automation systems are able to control various aspects of building operation by controlling the field devices.

Large commercial and industrial facilities have numerous field devices that are used for environmental control purposes. These field devices may be referred to herein as “environmental control devices.” Optimizing commercial and industrial building energy use includes allowing occupants to interact with their building automation system through these environmental control devices to provide feedback on comfort related to temperature, ventilation, lighting, and occupancy states. Occupants have the ability to reduce energy waste by, for example, setting unused spaces to unoccupied modes and reducing overconditioning of spaces. Problems with involving occupants with efficient building operation include providing access to the commercial system as well as then encouraging building occupants to engage in optimizing the energy use of a building. Additionally, these approaches require either proactive action by users (such as adjusting setpoints on a thermostat) or specialized equipment (such as occupancy sensors).

More recently, wired and wireless network approaches have been employed, where networked or smart switches and thermostats have been accessed and controlled by occupants to adjust the environment they are currently in, such as an office, conference room, hotel room, or dorm room, via a computer, wireless device, and mounted control devices that communicate with the building data networks. Because the practice of allowing building occupants to interact directly with the building automation system to set their preferable environmental settings has become an acceptable practice in the building control industry, it is highly desirable to promote energy efficient operation and energy saving behavior by allowing building occupants additional approaches and methods to modify and adjust environmental settings.

In view of the foregoing, there is an ongoing need for systems, apparatuses and methods for promoting desired user behavior and interaction with building automation systems.

### SUMMARY

In view of the above, an approach is provided for defining spaces within a building by generating a virtual perimeter that geographically defines each space and associating end users and occupants of each space with their respective spaces. The spaces within a building may be an entire floor of a multi-story building or portions thereof, rooms within a multi-unit building, or cubicles or other divided areas within commercial office spaces, or any other areas that may be geographically defined.

The end users and occupants of each space, who may be tenants of a building, students in a dormitory, occupants of a hotel, or visitors to any of the foregoing, are associated with their respective spaces by way of their personal mobile communication devices that have been provided with a location-based app by a building automation system (BAS). Each end user and occupant is identifiable to the BAS, which receives notifications from the mobile devices when the location of the end users and occupants changes relative to their respective spaces defined by the virtual perimeter, e.g., when an occupant enters or exits a space. Based on the notifications, the BAS may undertake certain desired actions, such as turning down a thermostat, turning off lights and other appliances, closing blinds, and arming or de-arming a security system.

In another approach, rewards may be given for meeting predetermined thresholds of activity or being the best performer, to give but a few examples, to those occupants who utilize their location-based apps to interact with the BAS in order to improve energy efficient operation and promote energy saving behavior.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 shows an exemplary topology diagram for a building automation system approach having an environmental control access panel;

FIG. 2 shows an exemplary block diagram of a building automation system of the building network of FIG. 1;

FIG. 3 shows an exemplary internal block diagram of a field panel for the building automation system of FIG. 2;

FIG. 4 shows an exemplary block diagram of a BAS server for the building automation system of FIG. 2 with a scoring feedback module;

FIG. 5 shows an exemplary topology diagram of a cloud-based approach for connecting numerous remote devices with the building automation system of FIG. 2;

FIG. 6 illustrates a flow diagram of a method of connecting a plurality of remote mobile communications devices with the building automation system of FIG. 2 using a cloud-based approach.

FIG. 7 illustrates a flow diagram of another method of connecting a plurality of remote mobile communications devices with the building automation system of FIG. 2 incorporating a gaming approach implemented by the scoring feedback module in the BAS server 102 of FIG. 4.

### DESCRIPTION

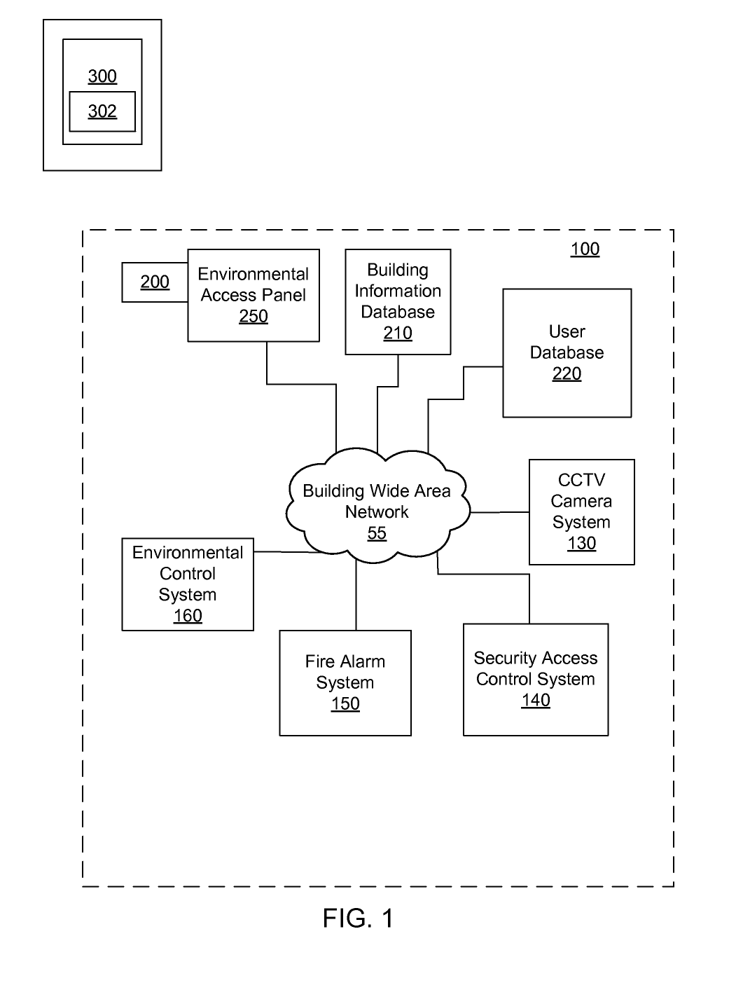

An example approach for modification of environmental settings is presented. In the example, the environmental settings of a building automation system (BAS) are modified responsive to notifications received from mobile devices associated with occupants of spaces within a building. When an occupant becomes entitled to occupy a particular space, e.g., a student occupying a college dormitory or a customer checking into a hotel, the occupant downloads a location-based app (such as the geo-fencing perimeter manager module or application 302 shown in FIG. 1) into his or her mobile device. Once activated, the location-based app may periodically determine the location of the occupant's wireless communication device using various location-based services (LBS), which include Global Positioning System (GPS)-based LBS, Global System for Mobile Communications (GSM) localization services, as well as short-range location services such as Bluetooth beacons.

Thereafter, the present location of the occupant's mobile communications device as determined by its LBS will be compared with the predetermined geographical perimeter of the occupant's assigned space to determine the distance, if any, between the present location of the occupant's mobile communications device and the predetermined geographical perimeter. If the distance indicates a change in the status of the occupant, i.e., the occupant has either vacated his space or conversely, reentered his space, then a notification is generated that awakens the mobile communications device, which in turn sends a command to an application server.

The application server may be any type of server operative in cloud-based infrastructures whereby numerous and various remote devices may access services in the cloud through several types of application program interfaces (APIs). In this example approach, the application server receives commands from the mobile communications devices and then may send notifications to the BAS that makes modifications and/or changes to one or more of the various components of the BAS.

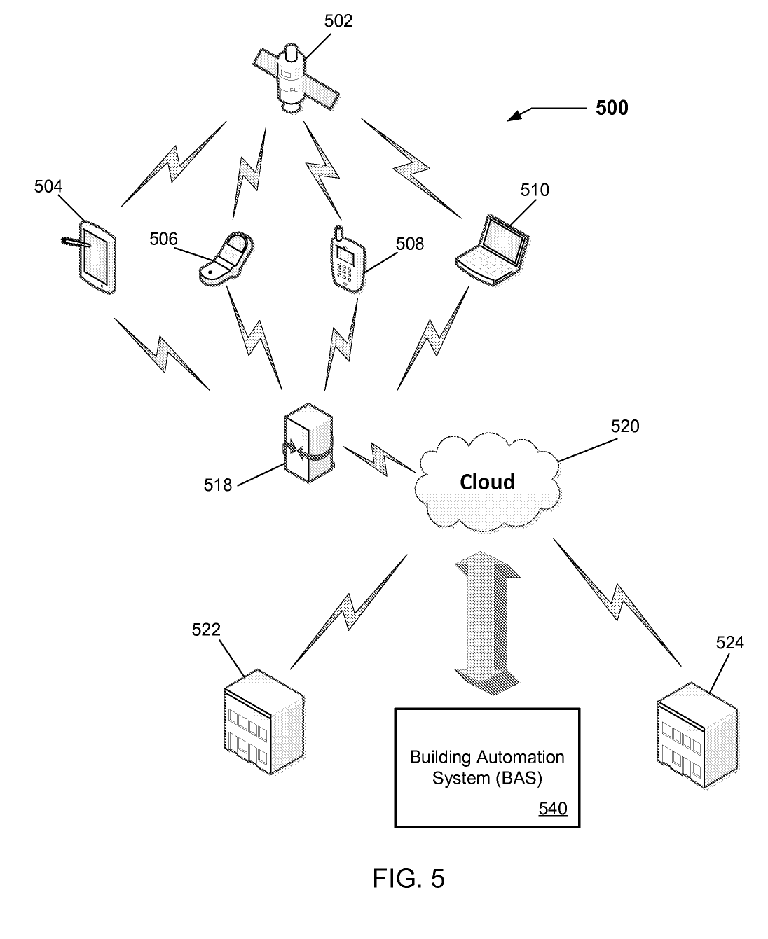

With reference to FIG. 1, an exemplary topology diagram for a building automation system approach is shown. The building wide area network 55 includes a plurality of systems and components in wired or wireless communication. The building wide area network 55 generally includes a plurality of building automation systems and may be accessed via a “building synergistic interface system” or “BSIS”. The BSIS 200 may be in signal communication with one or more mobile computing devices 300 (sometimes referred to as smart devices or mobile communication devices such as devices 504, 506, 508 and 510 shown in FIG. 5) that are able to communicate with the BSIS 200 that may be part of an environmental control access panel 250. Examples of smart devices or mobile computing devices 300 include smart cellular telephones, notebook and laptop computers, pad computers, eBook readers, and digital music players, such as iPods®.

The BSIS 200 further may include access to a data storage device comprising a building information database 210 and a user database 220. Software for communicating environmental and other data to the BSIS 200 may be stored on both the mobile computing device 300 and/or the building automation system 100. As will be explained herein, the BSIS 200 enables one or more of the environmental settings in a building automation system to be adjusted based on human actions without a network connection between the mobile computing device 300 and the BSIS 200. In addition, as described in further detail herein, the mobile computing device 300 may include a geo-fencing perimeter manager module or application 302 that enables the mobile computing device 300 to (i) derive and/or identify a geo-fence perimeter associated with a pre-determined location of a building space or room managed by the building automation system 100 or 540, and (ii) generate notifications to the building automation system 100 (or 540 in FIG. 5) to inform the system 100 or 540 of changes in the status of the location of the respective mobile computing device 300 relative to the geo-fence perimeter associated with a building space or room.

In the following pages, the general arrangement of an exemplary building automation system 100 configured for use with the BSIS 200 is explained first. Thereafter, the general arrangement of the environmental control access panel 250 is explained followed by the general arrangement of the mobile computing device 300. Overall operation of the BSIS 200 is discussed following the description of the building automation system (BAS), environmental access control panel 250, and the mobile computing device 300.

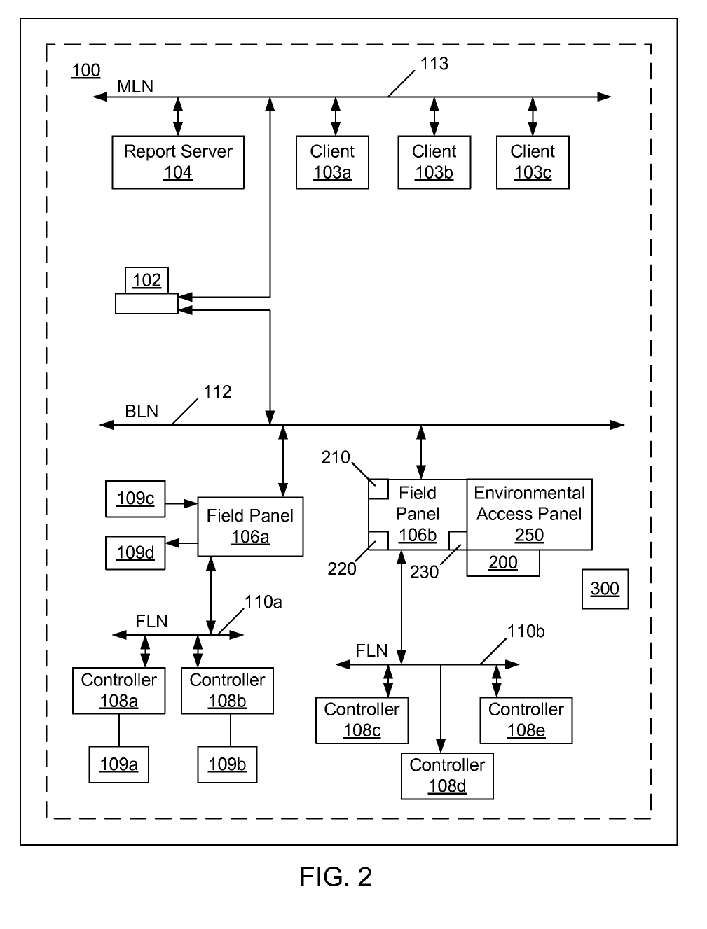

In the example embodiment of FIG. 1, the BAS 100 includes a building information database 210, user database 220, closed circuit television system 130, a security system 140, a fire alarm system 150, and an environmental control system 160. In FIG. 2, a system block diagram of an exemplary building automation system (BAS) 100 within a building or campus is depicted. The BAS is depicted as a distributed building system that provides control functions for any one of a plurality of building operations, such as environmental control, security, life or fire safety, industrial control and/or the like. An example of a BAS is the Apogee® building automation system available from Siemens Industry, Inc., Building Technologies Division, of Buffalo Grove, Ill. The Apogee® building automation system allows the setting and/or changing of various controls of the system, generally as provided below. While a brief description of an exemplary BAS is provided in the paragraphs below, it should be appreciated that the BAS 100 described herein is only an exemplary form or configuration for a building automation system.

With particular reference to FIG. 2, the BAS 100 includes at least one supervisory control system or workstation 102, client workstations 103a-103c, report server 104, a plurality of field panels represented by field panels 106a and 106b, and a plurality of controllers represented by controllers 108a-108e. It will be appreciated, however, that wide varieties of BAS architectures may be employed.

Each of the controllers 108a-108e represents one of a plurality of localized, standard building control subsystems, such as space temperature control subsystems, lighting control subsystems, or the like. Suitable controllers for building control subsystems include, for example, the model TEC (Terminal Equipment Controller) available from Siemens Industry, Inc., Building Technologies Division, of Buffalo Grove, Ill. To carry out control of its associated subsystem, each controller 108a-108e connects to one or more field devices, such as sensors or actuators, shown by way of example in FIG. 2 as the sensor 109a connected to the controller 108a and the actuator 109b connected to controller 108b.

Typically, a controller such as the controller 108a affects control of a subsystem based on sensed conditions and desired set point conditions. The controller controls the operation of one or more field devices to attempt to bring the sensed condition to the desired set point condition. By way of example, consider a temperature control subsystem that is controlled by the controller 108a, where the actuator 109b is connected to an air conditioning damper and the sensor 109a is a room temperature sensor. If the sensed temperature as provided by the sensor 109a is not equal to a desired temperature set point, then the controller 108a may further open or close the air conditioning damper via actuator 109b to attempt to bring the temperature closer to the desired set point. It is noted that in the BAS 100, sensor, actuator and set point information may be shared between controllers 108a-108e, the field panels 106a and 106b, the work station 102 and any other elements on or connected to the BAS 100.

To facilitate the sharing of such information, groups of subsystems such as those connected to controllers 108a and 108b are typically organized into floor level networks or field level networks (“FLNs”) and generally interface to the field panel 106a. The FLN data network 110a is a low-level data network that may suitably employ any suitable proprietary or open protocol. Subsystems 108c, 108d and 108e along with the field panel 106b are similarly connected via another low-level FLN data network 110b. Again, it should be appreciated that wide varieties of FLN architectures may be employed.

The field panels 106a and 106b are also connected via building level network (“BLN”) 112 to the workstation 102 and the report server 104. The field panels 106a and 106b thereby coordinate the communication of data and control signals between the subsystems 108a-108e and the workstation 102 (operating as a supervisory computer) and report server 104. In addition, one or more of the field panels 106a, 106b may themselves be in direct communication with and control field devices, such as ventilation damper controllers or the like. To this end, as shown in FIG. 2, the field panel 106a is coupled to one or more field devices, shown for example as a sensor 109c and an actuator 109d.

The workstation (server in other implementations) 102 provides overall control and monitoring of the BAS 100 and includes a user interface. The workstation 102 may further operate as a BAS data server that exchanges data with various elements of the BAS 100. The BAS data server can also exchange data with the report server 104. The BAS data server 102 allows access to the BAS system data by various applications. Such applications may be executed on the workstation 102 or other supervisory computers (not shown).

With continued reference to FIG. 2, the workstation 102 is operative to accept modifications, changes, alterations and/or the like from the user. This is typically accomplished via a user interface of the workstation 102. The user interface may include a keyboard, touch screen, mouse, or other interface components. The workstation 102 is operable to, among other things, affect or change operational data of the field panels 106a, 106b as well as other components of the BAS 100. The field panels 106a and 106b utilize the data and/or instructions from the workstation 102 to provide control of their respective controllers.

The workstation 102 is also operative to poll or query the field panels 106a and 106b for gathering data. The workstation 102 processes the data received from the field panels 106a and 106b, including trending data. Information and/or data is thus gathered from the field panels 106a and 106b in connection with the polling, query or otherwise, which the workstation 102 stores, logs and/or processes for various uses. To this end, the field panels 106a and 106b are operative to accept modifications, changes, alterations and/or the like from the user.

The workstation 102 also preferably maintains a database associated with each field panel 106a and 106b. The database maintains operational and configuration data for the associated field panel. The report server 104 stores historical data, trending data, error data, system configuration data, graphical data and other BAS system information as appropriate. In at least one embodiment, the building information database 210 and the user database 220 may be accessed by the BSIS 200 via the BAS server 102. In other embodiments the building information database 210 and the user database 220 may be stored elsewhere, such as workstation 102.

The management level network (“MLN”) 113 may connect to other supervisory computers and/or servers, internet gateways, or other network gateways to other external devices, as well as to additional network managers (which in turn connect to more subsystems via additional low level data networks). The workstation 102 may operate as a supervisory computer that uses the MLN 113 to communicate BAS data to and from other elements on the MLN 113. The MLN 113 may suitably comprise an Ethernet or similar wired network and may employ TCP/IP, BACnet, and/or other protocols that support high speed data communications.

FIG. 2 also shows that the BAS 100 may include a field panel 106b that is shown in FIG. 2 as a housing that holds the building information database 210, the user database 220, and the environmental access panel 250 having BSIS 200. The mobile computing device 300 is configured for wireless communications with the BAS 100 via the environmental access panel 250 provided on the field panel 106b. While the foregoing BSIS members are shown in FIG. 2 as being associated with one of the field panels 106b, it will be recognized that in other embodiments these and other BSIS members may be differently positioned in or connected to the BAS 100. For example, the building information database 210 and the user database 220 of the BSIS could be provided on the workstation 102. Alternatively, the building information database 210 and the user database 220 could be housed separately from those components shown in FIG. 2, such as in a separate computer device that is coupled to the building level network 112 or other BAS location. Such a separate computer device could also be used to store BSIS operational software. Similarly, the environmental access panel 250 with BSIS 200 may be housed within the workstation 102 or within a separate computer device coupled to the building level network 112 of the BAS.

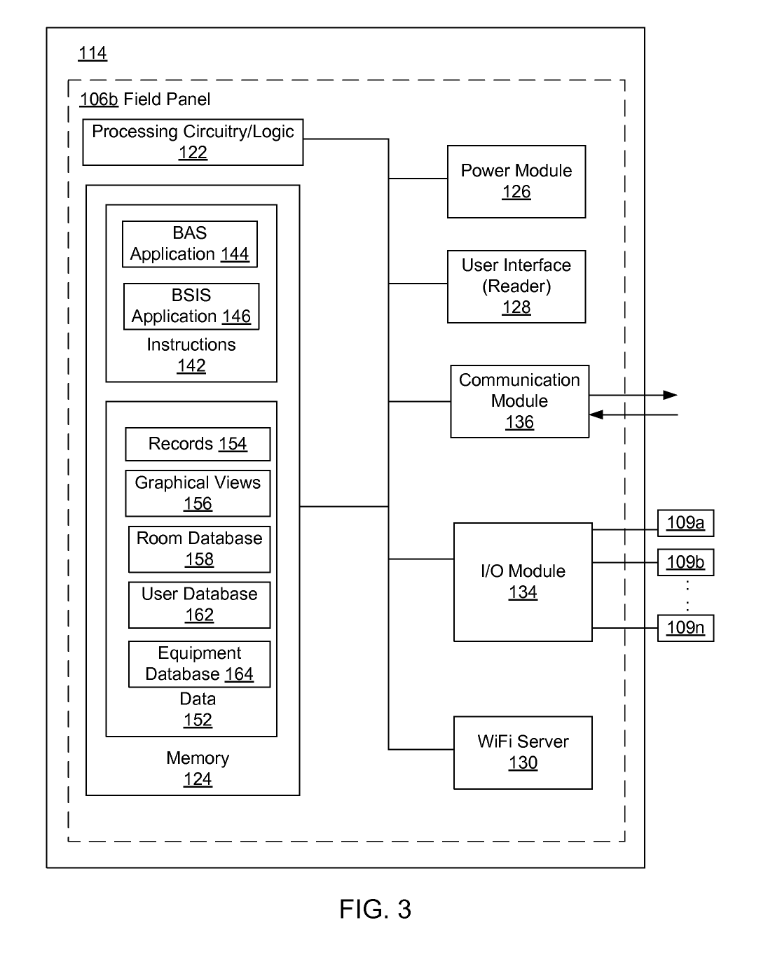

With reference now to FIG. 3, a block diagram of an exemplary embodiment of the field panel 106b of FIG. 2 is shown. It should be appreciated that the embodiment of the field panel 106b is only an exemplary embodiment of a field panel in a BAS 100 coupled to the BSIS 200. As such, the exemplary embodiment of the field panel 106b of FIG. 3 is a generic representation of all manners or configurations of field panels that are operative in the manner set forth herein.

The field panel 106b of FIG. 3 includes a cabinet or the like 114 that is configured in a typical manner for a building automation system field panel. The field panel 106b includes processing circuitry/logic 122, memory 124, a power module 126, a user interface 128, an I/O module 134, a BAS network communications module 136, and the Wi-Fi server 130.

The processing circuitry/logic 122 is operative, configured and/or adapted to operate the field panel 106b including the features, functionality, characteristics and/or the like as described herein. To this end, the processing circuitry logic 122 is operably connected to all of the elements of the field panel 106b described below. The processing circuitry/logic 122 is typically under the control of program instructions or programming software or firmware contained in the instructions 142 area of memory 124, explained in further detail below. In addition to storing the instructions 142, the memory also stores data 152 for use by the BAS 100 and/or the BSIS 200.

The field panel 106b also includes a power module 126 that is operative, adapted and/or configured to supply appropriate electricity to the field panel 106b (i.e., the various components of the field panel). The power module 126 may operate on standard 120 volt AC electricity, but may alternatively operate on other AC voltages or include DC power supplied by a battery or batteries.

An input/output (I/O) module 134 is also provided in the field panel 106b. The I/O module 134 includes one or more input/output circuits that communicate directly with terminal control system devices such as actuators and sensors. Thus, for example, the I/O module 134 includes analog input circuitry for receiving analog sensor signals from the sensor 109a, and includes analog output circuitry for providing analog actuator signals to the actuator 109b. The I/O module 134 typically includes several of such input and output circuits.

The field panel 106b further includes a BAS network communication module 136. The network communication module 136 allows for communication to the controllers 108c and 108e as well as other components on the FLN 110b, and furthermore allows for communication with the workstation 102, other field panels (e.g., field panel 106a) and other components on the BLN 112. To this end, the BAS network communication module 136 includes a first port (which may suitably be a RS-485 standard port circuit) that is connected to the FLN 110b, and a second port (which may also be an RS-485 standard port circuit) that is connected to the BLN 112.

The field panel 106b may be accessed locally. To facilitate local access, the field panel 106b includes an interactive user interface 128. Using user interface 128, the user may control the collection of data from devices such as sensor 109a and actuator 109b. The user interface 128 of the field panel 106b includes devices that display data and receive input data. Reception of input data may include a code reader device, such as a Quick Response (QR) code reader. These devices may be devices that are permanently affixed to the field panel 106b or portable and moveable. The user interface 128 may also suitably include an LCD type screen or the like, and a keypad. The user interface 128 is operative, configured and/or adapted to both alter and show information regarding the field panel 106b, such as status information, and/or other data pertaining to the operation, function and/or modifications or changes to the field panel 106b.

As mentioned above, the memory 124 includes various programs that may be executed by the processing circuitry/logic 122. In particular, the memory 124 of FIG. 3 includes a BAS application 144 and a BSIS building application 146. The BAS application 144 includes conventional applications configured to control the field panel 106b of the BAS 100 in order to control and monitor various field devices 109a-n of the BAS 100. Accordingly, execution of the BAS application 144 by the processing circuitry/logic 122 results in control signals being sent to the field devices 109a-n via the I/O module 134 of the field panel 106b. Execution of the BAS application 144 also results in the processor 122 receiving status signals and other data signals from various field devices 109a-n, and storage of associated data in the memory 124. In one embodiment, the BAS application 144 may be provided by the Apogee® Insight® BAS control software commercially available from Siemens Industry, Inc. or another BAS control software.

In addition to the instructions 142, the memory 124 may also include data 152. The data 152 includes records 154, graphical views 156, a room database 158, a user database 162, and an equipment database 164. The records 154 include current and historical data stored by the field panel 106b in association with control and operation of the field devices 109a-n. For example, the records 154 may include current and historical temperature information in a particular room of the building 99, as provided by a thermistor or other temperature sensor within the room. The records 154 in the memory may also include various set points and control data for the field devices 109, which may be pre-installed in memory 124 or provided by the user through the user interface 128. The records 154 may also include other information related to the control and operation of the 100 BAS and BSIS building application 146, including statistical, logging, licensing, and historical information.

The graphical views 156 provide various screen arrangements to be displayed to the user via the user interface 128. The user interface 128 may be displayed at thermostats with displays or other user access points having displays, such as liquid crystal displays, light emitting diode displays, or other known types of visual displays devices.

The room database 158 may include data related to the layout of the building 99. This room database 158 includes a unique identifier for each room or area within the building (e.g., room “12345”). In addition to the unique identifier data, the room database 158 may include other information about particular rooms or areas within the building 99. For example, the room database 158 may include information about field devices located within the room or area, particular equipment (e.g., research equipment, manufacturing equipment, or HVAC equipment) positioned within the room or area. The room database 158 may also include GPS coordinates (e.g., latitude, N or S, and latitude, E or W, in degrees, minutes, and seconds) from which geographical perimeters may be derived or calculated for each room or area within a building).

The user database 162 may include data related to human users who frequent the building 99. Accordingly, the user database 162 may include a unique identifier for each human user (e.g., user “12345”) and a user profile associated with that user. In other implementations, each room or area may have a profile that has one or more users associated with it. The user profile may include information provided by the user or provided by third parties about the user. For example, the user profile may include a preferred temperature or lighting level for the user, which is provided to the user database 162 by the user. Also, the user profile may include a security clearance level, room access, or data access for the user, all provided to the database 162 by a third party, such as the human resources department or security department for the employer who owns the building 99. Moreover, the user profile may include data related to the term and nature of the user's occupancy of an associated room or area, e.g., a move-in date, a move-out date, etc.

The equipment database 164 may include data related to various pieces of equipment within the building 99. The equipment may include field devices associated with the BAS 100 or other equipment that is positioned within the building 99. For example, the equipment database 164 may include information related to manufacturing or research equipment located in a particular room of the building. The equipment database 164 maintains a unique identifier for each piece of equipment (e.g., equipment “12345”) and data associated with that equipment. For example, the database 164 may associate particular schematics, operation manuals, photographs, or similar data with a given piece of equipment within the database 164.

While the field panel 106b has been explained in the foregoing embodiment as housing the BSIS building application 146 and various BSIS databases, such as the room database 158, user database 162, and equipment database 164, it will be recognized that these components may be retained in other locations in association with the BAS 100. For example, these components could all be retained within the central workstation 102 of the BAS 100 or a separately designated BSIS computing device in the BAS 100.

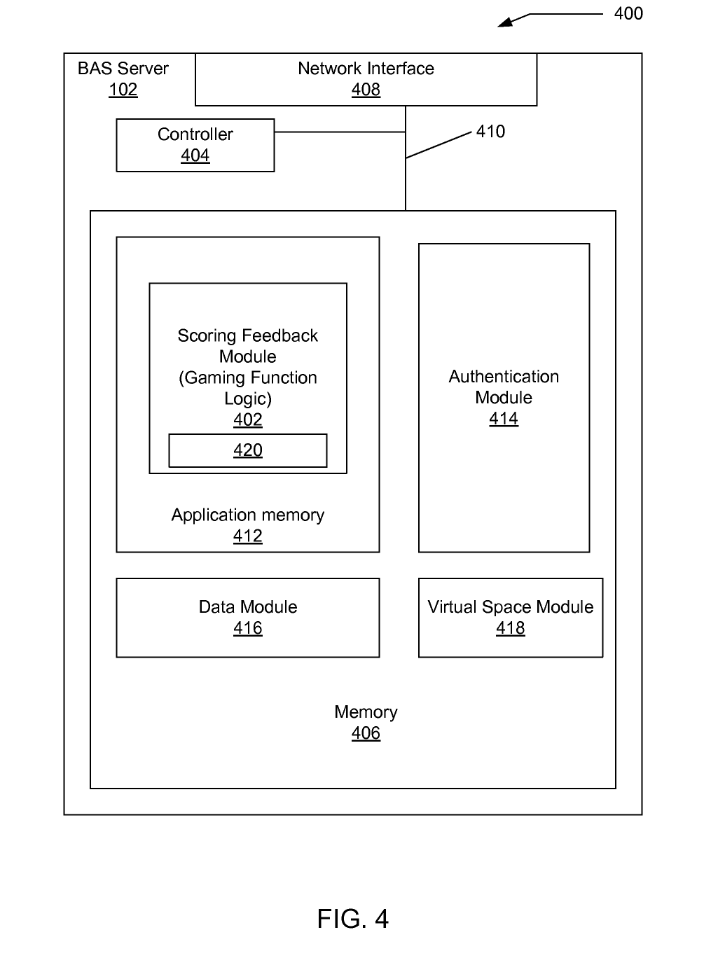

Turning to FIG. 4, an exemplary block diagram 400 of BAS server 102 of FIG. 2 with a scoring feedback module 402 is illustrated. The BAS server 102 has a controller 404 that executes machine readable instructions stored in memory or accessed via the network. Examples of a controller 404 may include a microprocessor having one or more cores, microcontroller, application specific integrated circuit (ASIC), digital signal processor, digital logic devices configured to execute as a state machine, analog circuits configured to execute as a state machine, or a combination of the above. The controller 404 is typically electronically coupled to memory 406, network interface 408 and other parts of the server via one or more buses (represented as bus 410). The memory 406 may be random access memory, SDRAM, DIMM, or other types of digital storage capable of read/write access. The network interface 408 is an Ethernet network connection in the current implementation. In other implementations, additional or other types of data network interfaces may be employed.

Within the memory 406, there may be areas for applications 412, authentication module 414, data module 416, and virtual space module 418. One of the applications or modules that may be stored and executed from the application memory 412 is a scoring feedback module 402. Another term for the scoring feedback module 402 is gaming function logic. In addition to the scoring feedback module 402, other BAS applications (not shown in FIG. 4) may be stored and executed in the application memory 412.

The authentication module 414 may contain user identification information, such as login, permission, expiration time, email address, location information. A person accessing a BAS 100 with an external device, such as a computer, smart phone, or other personal computing device to change an environmental parameter may require the person to log into the BAS 100. The authentication and user information for accessing the BAS 100 may reside in the authentication module 414. In other implementations, the authentication module 414 may be distributed among multiple servers and databases, implemented on a standalone server, or combined with other modules.

The virtual space module 418 may contain a database or data structure that maps or groups points in the BAS 100 into groups that may represent physical rooms, such as a dorm room, conference room, or similar location. Virtual locations may also be defined, such as a grouping of cubicles in an office and a grouping of rooms. Both the physical locations and the virtual locations may have their respective GPS coordinates included in the virtual space module 418 from which geographical perimeters may be derived or calculated for each physical location and virtual location within a building). The virtual space module 418 may be accessed by the authentication module 414 and an association created between users and groups of points (i.e., virtual spaces). The association is stored in the current example in the authentication module 414. In other implementations the associations may be stored in the scoring feedback module 402, data module 416, the virtual space module 418, or on a different server.

The data module 416 is an area of memory for storing data and variables used by applications in the application memory. The data module 416 may also contain data used by the hardware of the BAS server 102.

The scoring feedback module 402 in application memory 412, when executed by the controller 404 enables user behavior to be modified through positive reinforcement, negative reinforcement, or a combination of positive and negative reinforcement. The scoring feedback module 402 is also capable of storing multiple gaming rules for scoring the game, evaluating user behavior, and reinforcing the behavior. Further, the scoring feedback module 402, may also have a plurality of rules 420 for defining one or more “games.” The rules are implemented as a group of database calls executed by the controller that process the BAS data and user inputs in order to “score” the “game.” In other implementations, hard coded predefined rules may be employed.

Turning to FIG. 5, an exemplary topology diagram of a cloud-based approach for connecting numerous remote mobile communications devices with the building automation system of FIG. 2 is shown. These remote mobile communications devices may include a tablet computer 504, such as an iPad®, a cell phone 506, a Smart phone 508, such as an iPhone®, and a laptop computer 510. All of these remote mobile communications devices are in signal communication with satellite 502, and thus are GPS-enabled and operative to determine the location of each respective remote mobile communications device.

The remote mobile communications devices are connected to a gateway server 518, which in turn connects to an Internet-based infrastructure (or “cloud’) 520. The gateway server 518 enables remote mobile communications devices connections to a corporate network that includes the BAS 540 from the Internet without having to set up virtual private network (VPN) connections. Through the Internet-based infrastructure 520, the remote mobile communications devices are able to utilize certain applications and services (such as geo-fencing perimeter manager 302) that allow these remote mobile communications devices to generate notifications to BAS 540 that inform BAS 540 of changes in the status of the location of each mobile communications device relative to its user's associated building space.

The BAS may also be in communication, through the cloud 520, with one or more buildings, in FIG. 5 shown as building “A” 522 and building “B” 524. Rooms and spaces in these building may be defined as a location in terms in terms of GPS coordinates and stored by the BAS 540 (consistent with the BAS 100 as described herein) in the room database 158 of the field panel 106a or 106b associated with the building “A” 522 or building “B” 524 having the respective room or space. The BAS 540 may also store, in association with the GPS location or coordinates of the space or room in the same room database 158, pre-determined perimeter parameters such as one or more dimensions of the respective room or space and/or a corresponding perimeter definition such as an algorithm for deriving a perimeter. The stored perimeter parameters and GPS location or coordinates of the space or room collectively define perimeter data from which geographical perimeters (also referred to as a “geo-fencing perimeter”) may be derived or calculated for each room or area within a building by the BAS 540 or by the occupant's personal mobile communications device (MCD) in communication with the BAS 540 via the network or Internet-based infrastructure or cloud 520 in accordance with methods of operation further described herein. Once derived or calculated, these geo-fencing perimeters may stored by the BAS 540 into the room database 158 of field panel 106b of FIG. 3 as well as building information database 210 of the BAS 540 consistent with the BAS 100 shown in FIG. 1.

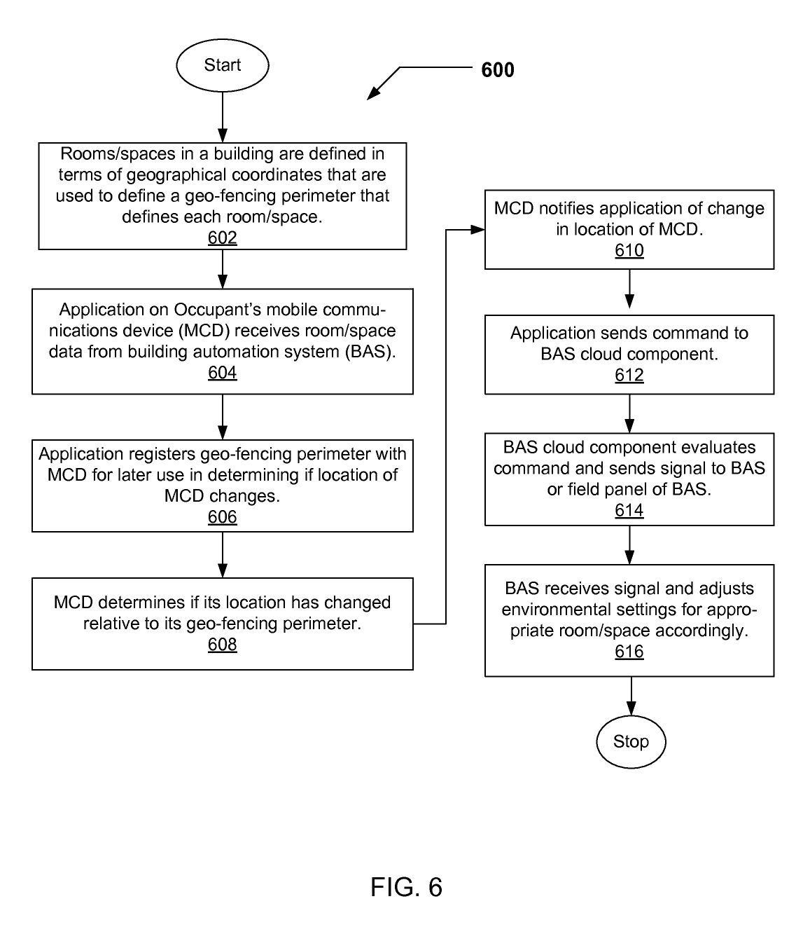

In a method of operation, once occupants are assigned to any of these rooms or spaces, i.e., have a right to occupy or to enter these rooms and/or spaces, information related to these occupants may be entered into the user database 162 of field panel 106b of FIG. 3 and user database 220 of FIG. 1. This information may include associating each user with his/her room or space and also information related to the occupant's personal mobile communications device, examples of which include devices 504, 506, 508, and 510 of FIG. 5. Once the occupant is authenticated to the BAS 540, changes in the location of the personal mobile communications device (MCD) relative to the occupied room or space cause or prompt the geo-fencing perimeter manager module or application 302 of the MCD to generate a corresponding notification to the BAS 540, which in turn leads the BAS 540 to automatically modify and adjust environmental settings of the BAS 540 as shown in more detail in FIG. 6.

It is appreciated by those skilled in the art that the cloud-based approach shown in FIG. 5 is only an exemplary topology diagram of a cloud-computing methodology and that for the purpose of connecting numerous remote devices with a building automation system, a cloud-based implementation may take other forms and include other components, such as internal and external firewalls, Web servers, proxy servers, and the like.

In FIG. 6, a flow diagram 600 of a process of connecting a plurality of remote mobile communications devices with the BAS of FIG. 2 using a cloud-based approach is shown. The purpose of connecting the remote mobile communications devices with a BAS using a cloud-based approach is to enable remote mobile communications devices, which may be associated with room or spaces in a building, to communicate with a BAS so that when a change in the location of a respective remote mobile communications device (MCD) relative to the associated room or space occurs, indicating that the status of the occupancy has changed, the BAS is notified by the respective MCD of the change and makes the appropriate adjustments to the BAS controlling the room or space for the user of the MCD. All adjustments may be made without any interaction on the part of the MCD user or occupant.

In step 602, rooms and/or spaces are defined in terms of geographical coordinates that are used to define a geo-fencing perimeter that defines the desired room or space. The rooms and spaces may include rooms in a dorm or hotel, cubicles in an office, floors in a multi-floor building, or portions of a floor. Also included are virtual spaces, which may be any grouping of physical rooms or spaces into an arbitrary configuration defined by a user. As described herein, rooms and spaces in these buildings may be defined as a location in terms in terms of GPS coordinates that are stored by the BAS 540 (consistent with the BAS 100 as described herein). In one implementation, a facility manager of the buildings may use a BAS commissioning tool (not shown in the figures) or user interface of the BAS server 102 for input/output communication with the virtual space module 418 or user interface 128 of the respective field panel 106a or 106b in order to identify to the BAS 540 the GPS coordinates or location of each space and/or room of the building 522 or 524. The BAS 540 may then store the identified GPS coordinates or location of each room and/or space in the room database 158 of the field panel 106a or 106b associated with the corresponding buildings 522 or building 524 having the respective room or space. In this implementation, the BAS 540 also stores, in association with the GPS location or coordinates of the space or room in the database 158, pre-determined perimeter parameters (e.g., dimensions of the respective room or space and/or a corresponding perimeter definition such as an algorithm for deriving a perimeter) to collectively define perimeter data for the space or room.

In step 604, an application on the occupant's personal MCD receives from the BAS the perimeter data that defines the geo-fencing perimeter of his room or space once the occupant's tenancy has commenced. For example, when the occupant's personal MCD 504, 506, 508 or 510 has uploaded the geo-fencing perimeter manager application 302 and the geo-fencing manager application 302 is authenticated to the BAS 540, the BAS 540 is able to access the occupant's respective user profile to determine whether the user's or occupant's tenancy has commenced and then transmit the respective perimeter data associated with the occupant's room or space to the occupant's MCD. In one embodiment, the geo-fencing perimeter is derived or calculated by the geo-fencing perimeter manager application 302 of the occupant's MCD 504, 506, 508 or 510 based on the received perimeter data. In an alternative embodiment, prior to or in conjunction with transmitting the perimeter data to the occupant's MCD, the BAS 540 uses the perimeter data to derive or calculate the geo-fencing perimeter and then transmits the geo-fencing perimeter as part of the perimeter data to the occupant's MCD.

In step 606, once the occupant is authenticated to the cloud-based system of FIG. 5, the geo-fencing perimeter manager application 302 registers or stores the geo-fencing perimeter with the respective MCD for later use in determining if a present location of the MCD changes. The occupant's MCD uses its LBS to determine its present location and compares that new location against the geo-fencing perimeter of the occupant's room or space in step 608.

In step 608, the new location of the MCD is compared by the geo-fencing perimeter manager 302 (or the MCD's LBS) against the geo-fencing perimeter of the occupant's room or space to determine if the MCD's location has changed relative to the geo-fencing perimeter. In one embodiment, the geo-fencing perimeter manager 302 determines there is a change in location when the present location of the MCD is within the geo-fencing perimeter (e.g., entering or leaving the geo-fencing perimeter). In an alternative embodiment, the MCD's LBS may determine there is a change in location when the present location of the MCD is within the geo-fencing perimeter and then notify the geo-fencing perimeter manager 302 of this change of location in a step 610; otherwise, the process continues at step 612.

In step 612, the geo-fencing perimeter manager application 302 sends a command to a BAS cloud component, such as, for example, gateway 518 of cloud 520 as shown in FIG. 5. When the management level network (“MLN”) 113 of the BAS 540 or 100 is connected to the cloud 520, the BAS cloud component may be hosted on the BAS server 102 (e.g., as a component of scoring feedback module 402) or as an embedded web server on one of the field panels 106a or 106b of the BAS 540 or 100.

In step 614, upon receipt of the command, the BAS cloud component evaluates the command and sends a signal to the corresponding BAS, such as the BAS server 102 of BAS 100 of FIG. 1 and BAS 540 of FIG. 5, or directly to the field panels 106a and 106b of the corresponding BAS 100 or 540. The signal may be configured to inform the BAS or field panel of the change of the status of the room or space, e.g., occupied or unoccupied, number of occupants, etc.

In step 616, the BAS (via BAS server 102 or the field panel 106a or 106b) receives the signal and based on the signal adjusts the various environmental, security, fire safety, lighting, and HVAC systems of the building that may affect the room or space, all without the active participation of the occupant(s) of the room or space.

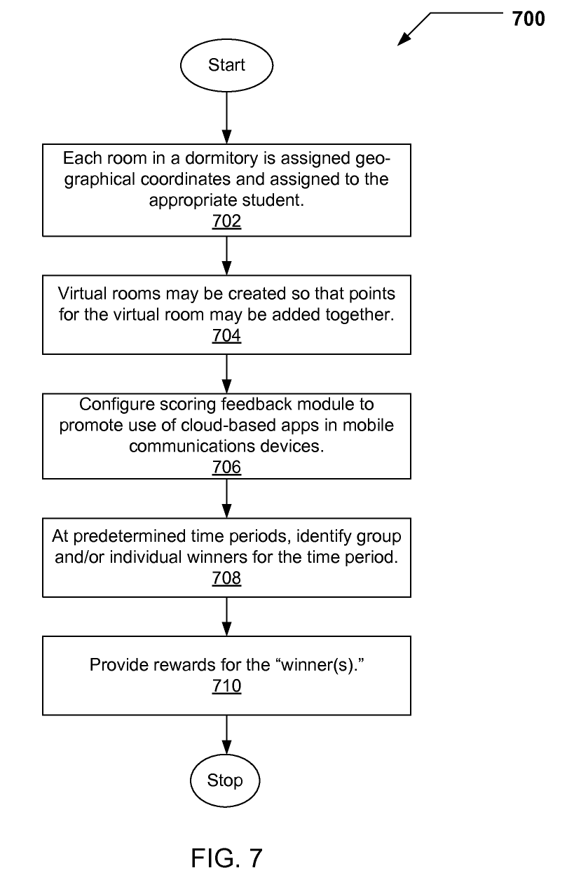

A second approach as shown in FIG. 7 may be implemented in the process of FIG. 6 by adding incentives for the occupant of a room or space to download the cloud-based application on his/her mobile communications device. In this second approach, students in a dorm may actively download the app to their respective mobile communications devices, but once downloaded no further participation is required of the students and the process proceeds automatically as in FIG. 6.

Turning to FIG. 7, a flow diagram 700 of a “game” implemented in the scoring feedback module 402 of FIG. 4 is illustrated. In the example of FIG. 7, the behavior of dorm students is rewarded for downloading a cloud-based app (e.g., 302) into their personal remote mobile communications devices which will enable a BAS to more efficiently control the energy usage of their dormitory, for example, by reducing the cooling or heating energy while the room is empty, resulting in energy savings. First, geographical coordinates are determined for each student's room and the room is then associated with the appropriate student in step 702.

A virtual room may be defined that combines dorm rooms where the points for that area's dorm rooms are grouped together 704. The scoring feedback module 402 of FIG. 4 is then configured to promote the use of the cloud-based apps in the students' personal mobile communications devices in step 706. The scoring feedback module 402 of FIG. 4 in the current example may be configured by of the cloud 520 of FIG. 5 via the Internet to record the students' acceptance of the cloud-based apps both individually and as a member of a virtual room.

At predetermined times, for example, weekly or monthly, winners are determined (step 708) and rewards are provided (step 710). Winners may be determined based on the percentage of students who have downloaded the cloud-based apps as well as an estimated energy savings achieved through use of the cloud-based apps. An example of a reward may be reduced utility payments for the month.

It will be understood and appreciated that one or more of the processes, sub-processes, and process steps described in connection with FIGS. 6 and 7 may be performed by hardware, software, or a combination of hardware and software on one or more electronic or digitally-controlled devices. The software may reside in an application memory in a suitable electronic processing component or system such as, for example, one or more of the functional systems, devices, components, modules, or sub-modules schematically depicted in the BAS server 102 of FIG. 4. The application memory may include an ordered listing of executable instructions for implementing logical functions (that is, “logic” that may be implemented in digital form such as digital circuitry or source code or in analog form such as an analog source such as an analog electrical, sound, or video signal). The instructions may be executed within a processing module, which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system, direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read-only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

What is claimed is:

1. A method of adjusting control devices of a building automation system (BAS), the method including the steps of:
generating a geo-fencing perimeter that defines a space in a building;
associating the space with an occupant authorized to occupy the space;
downloading a cloud-based application to a mobile communications device (MCD) under the control of the occupant; and
using location-based services (LBS) provided by the MCD to determine entering or leaving the geo-fencing perimeter.

2. The method of claim 1, further including the steps of
transmitting a command from the MCD to BAS configured to control the space when the LBS of the MCD detects the MCD entering or leaving of a geo-fencing perimeter.

3. The method of claim 2, further including the step of adjusting building control systems of the building responsive to the command received from the MCD.

4. The method of claim 3, where the BAS includes security systems, fire safety systems, lighting systems, and heating, ventilation, and air conditioning (HVAC) systems.

5. The method of claim 1, where the step of generating a geo-fencing perimeter further includes determining geographical coordinates of the space.

6. The method of claim 1, where the space in a building is a virtual space defined by geographical coordinates irrespective of physical dimensions.

7. The method of claim 1, where the step of comparing further includes:
determining a distance between the determined location of the MCD and the geo-fencing perimeter;
comparing the distance to a predetermined threshold limit; and
indicating a change of location if the threshold limit is exceeded.

8. An apparatus for adjusting control devices of a building automation system (BAS), comprising:
geo-fencing perimeters that define spaces in a building;
occupier identifiers that associate occupants with the geo-fencing perimeters;
a plurality of mobile communications devices under the control of the occupants;
a memory that stores the geo-fencing perimeters and the occupier identifiers;
an application in signal communication with the memory that executes a plurality of instructions that determines locations of each of the plurality of mobile communications devices and compares the locations against the corresponding geo-fencing perimeters.

9. The apparatus of claim 8, where the comparison of the locations of the mobile communications devices against the corresponding geo-fencing perimeters indicates whether the spaces are occupied or unoccupied.

10. The apparatus of claim 9, where the mobile communications devices include remote personal Global Positioning System (GPS)-enabled and Bluetooth-enabled mobile communications devices communicating over a wireless network with the BAS.
